(19) United States
(12) Patent Application Publication
(10) Pub. No.: US 2024/0160501 A1
(43) Pub. Date: May 16, 2024

(54) INTEROPERABILITY BETWEEN ACTOR FRAMEWORKS AND ASYNCHRONOUS FRAMEWORKS

(71) Applicant: MICROSOFT TECHNOLOGY LICENSING, LLC, Redmond, WA (US)

(72) Inventors: Timothy Douglas MacLean BELLIS, Cambridge (GB); Charles Richard STEDMAN, Cambridge (GB); Aatif Akhtar SYED, Cambridge (GB); David Allen Everitt MCNALLY, Ely (GB)

(21) Appl. No.: 18/326,391

(22) Filed: May 31, 2023

Related U.S. Application Data
(60) Provisional application No. 63/424,845, filed on Nov. 11, 2022.

(51) Int. Cl. G06F 9/54

(52) U.S. Cl. CPC G06F 9/541; G06F 9/546

(57) ABSTRACT

A first framework uses an actor pattern and a second framework uses an event based asynchronous pattern in a computing system. The computing system runs a compatibility layer configured to enable interoperation between the first framework and the second framework. A first message for a first component associated with the first framework is mapped to a second message that provides a corresponding result for a second component associated with the second framework.

### PRIORITY APPLICATION

This application claims the benefit of and priority to U.S. Provisional Application No. 63/424,845, filed Nov. 11, 2022, the entire contents of which are incorporated herein by reference.

### BACKGROUND

Many computing environments deploy systems and functions that were developed using paradigms and frameworks that have evolved over time. This may involve adopting new design paradigms, new programming languages, new libraries, etc. It is desirable to enable interoperability between different frameworks, which enables leveraging the reuse of code from older frameworks, while also adopting advantages from newer language features that were not available, for example, when functions were written for an original product.

It is with respect to these and other technical challenges that the disclosure made herein is presented.

### SUMMARY

An actor model uses an actor as a model for concurrent processing. An actor is a basic unit of computation that encapsulates both state and behavior. In response to a message that an actor receives, an actor can: make local decisions, create more actors, send more messages, and determine how to respond to the next message received. Actors can modify their own private state, but can only affect other actors indirectly through messaging. Event-based asynchronous frameworks allow for concurrent processing typically using multiple threads in the background without interrupting the main function and receiving notifications when a thread completes.

A computing environment can provide a framework for writing asynchronous applications using a given language that supports an asynchronous framework. It would be desirable to enable users to write code in the language using the asynchronous framework in a natural way, while at the same time allowing the code to be executed in a framework that implements an actor-based model. The disclosed embodiments provide an interoperation layer or a compatibility layer that enables the interoperation between a framework using the actor pattern and a framework using an event based asynchronous pattern. This allows developers to write code that appears to be synchronous, which is easier and less error prone, even though in operation, the framework can pause their functions and then resume them at a later time.

The interoperation layer or a compatibility layer disclosed herein can increase the reliability and performance of functions and applications and reduce development costs by avoiding having to rewrite or revise code for newer platforms and avoiding or reducing memory and threading bugs. More reliable and performant applications, in turn, result in better performing computing devices that utilize fewer processor cycles, less memory, and less power. Other technical benefits not specifically mentioned herein can also be realized through implementations of the disclosed subject matter.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a computer software architecture diagram that shows aspects of a framework as disclosed herein;

FIG. 1B is a computer software architecture diagram that shows aspects of a framework as disclosed herein;

FIG. 2A is diagram that shows aspects of a framework as disclosed herein;

FIG. 2B is a flow diagram illustrating aspects of a framework in accordance with the present disclosure;

FIG. 2C is a flow diagram illustrating aspects of a framework in accordance with the present disclosure;

FIG. 3 is a diagram showing aspects of a framework as disclosed herein;

FIG. 4 is a diagram showing aspects of a framework as disclosed herein;

FIG. 5 is a diagram showing aspects of a framework as disclosed herein;

FIG. 6 is a flow diagram illustrating an example procedure in accordance with the present disclosure;

FIG. 7 is a computer architecture diagram showing an illustrative computer hardware and software architecture for a computing device that can execute the disclosed framework and associated modules, such as those described with regard to FIGS. 1-6 and;

FIG. 8 is a network diagram illustrating a distributed computing environment in which aspects of the disclosed technologies can be implemented.

### DETAILED DESCRIPTION

The following detailed description is directed to a framework that enables interoperability between the actor pattern and the event based asynchronous pattern. While the subject matter described herein is presented in the general context of interoperability between the actor pattern and event based asynchronous pattern, those skilled in the art will recognize that other implementations might be performed in combination with other types of frameworks and patterns. Those skilled in the art will also appreciate that the subject matter described herein can be practiced with other computer systems and network configurations.

In the following detailed description, references are made to the accompanying drawings that form a part hereof, and which are shown by way of illustration specific configurations or examples. Referring now to the drawings, in which like numerals represent like elements throughout the several FIGS., aspects of a framework that can enable the interoperability between the actor pattern and event based asynchronous pattern will be described.

In various embodiments, a compatibility layer is described that provides a means of allowing code written in the asynchronous framework to appear as actors in the actor model or framework. The framework further provides a means of ensuring shared memory ownership and validation.

In an embodiment, the disclosed framework provides a means of allowing asynchronous code to await message receipt from an actor-based system. The framework further provides a means of non-blocking communication between actors and asynchronous threads. For example, structures from the asynchronous framework (e.g., in a Rust memory layout) are stored in a part of the memory belonging to the actors (which may be, e.g., in a C memory layout) and these structures are used to access shared state from the asynchronous threads. In another example, unknown structures are dynamically cast into specifically typed structures in a generic way. In a further example, requests and responses are generically correlated across threads using 2-stage correlation (type+correlator).

As used herein, an actor framework is a framework that a development environment may interoperate with. The actor framework has actors and a scheduler and a thread pool. The scheduler schedules actors to run on threads. Each actor has some context (e.g., thread local variables) which must be loaded whenever the actor is to perform a process, which is typical for many actor models. For performance purposes, the actor framework expects that actors return synchronously so that their threads can be reused for other actors.

In order to perform asynchronous work, each actor must be programmed to perform a synchronous step separately, reloading its context each time it is executed.

As used herein, an asynchronous framework is a framework that a development environment may utilize and interoperate with the actor framework. The asynchronous framework provides a means of allowing code to be written as if it were executed synchronously, but actually executes asynchronously (with the framework handling the loading of any required context), which is typical for many patterns. One means of communication between threads is by channels, which are a source of asynchronous work, so that messages on the channel can then be processed asynchronously by the asynchronous framework. Channels handle send/receive in a thread-safe manner and are provided by the framework.

In various embodiments disclosed herein, a compatibility layer is implemented that provides compatibility between the old (actor) and new (asynchronous) frameworks.

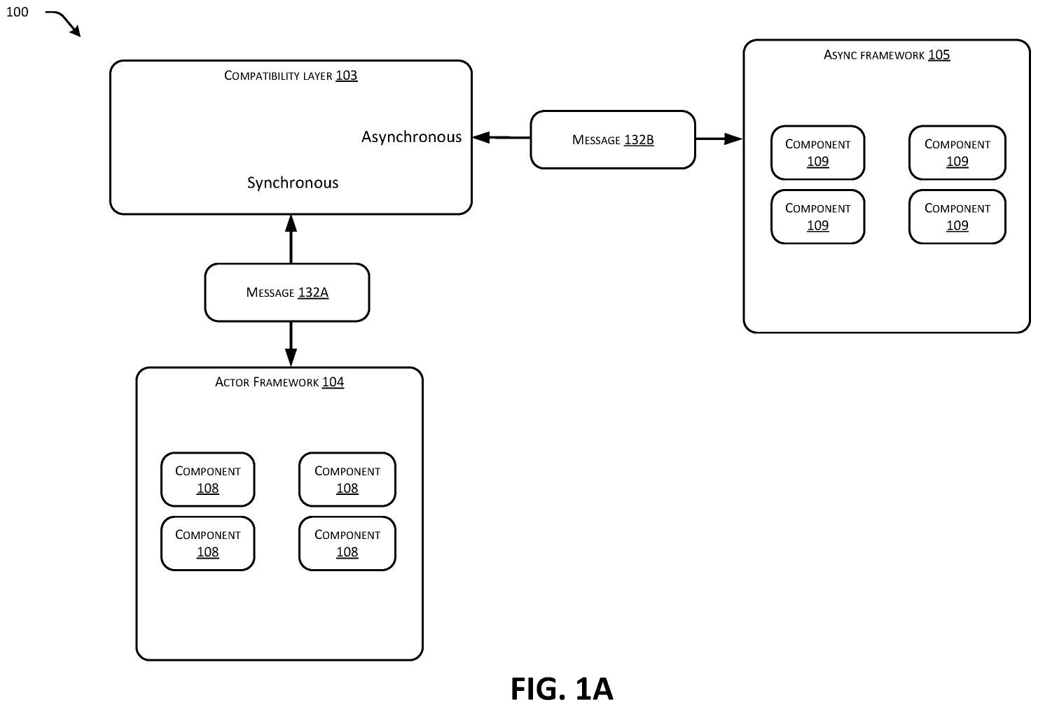

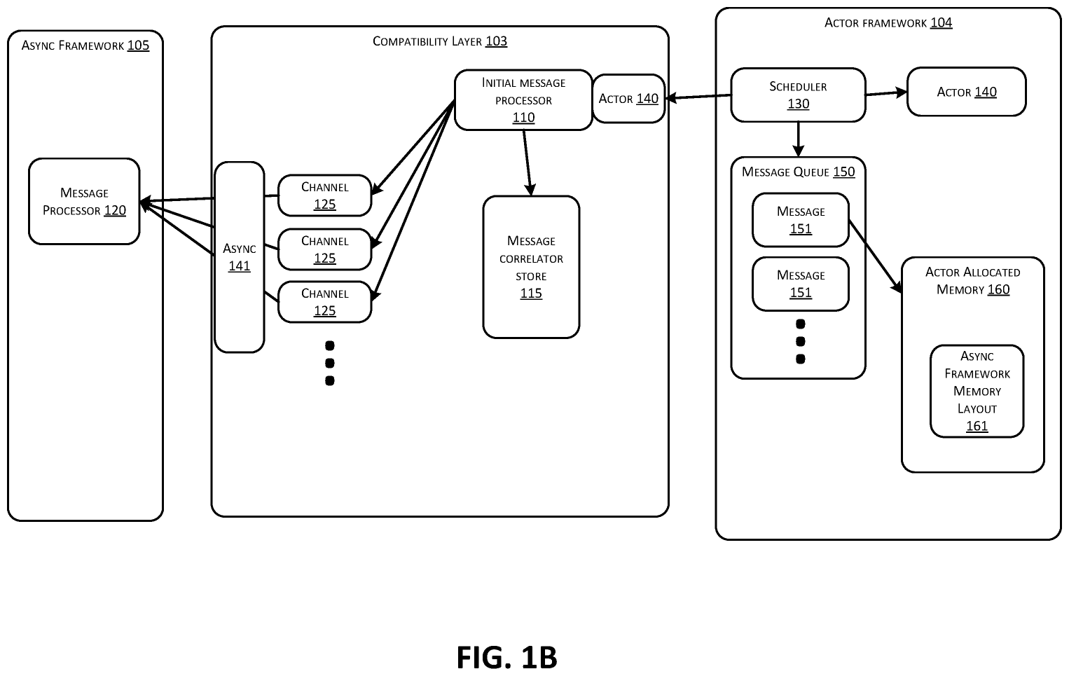

Referring to FIG. 1A, illustrated is an example of a compatibility layer according to one embodiment. FIG. 1 illustrates a first framework 104 and a second framework 105. FIG. 1A illustrates interoperation between the first framework 104 which, in one embodiment, uses an actor pattern and second framework 105, which in one embodiment, uses an event based asynchronous pattern. In other embodiments, the first framework 104 uses an event based asynchronous pattern and the second framework 105 uses an actor pattern.

The first framework 104 and second framework 105 are implemented in a system 100 running a compatibility layer 103 configured to enable interoperation between the first framework 104 and second framework 105. In various embodiments, system 100 can be a physical or virtual machine, or a distributed network of such computing devices.

A first message 132A is received for a first component 108 associated with the first framework 104 using the actor pattern framework. The first message 132A is mapped to a second message 132B that provides a corresponding result for a second component 109 associated with the second framework 105 using the event based asynchronous pattern programming framework. In an embodiment, the compatibility layer 103 enables translation between two threading models. In an example, the compatibility layer 103 can translate messages 132A in the first framework 104 to corresponding messages 132B in second framework 105. The second message 132B is sent to component 109 for processing by the second component 109. Additional messages 132A and 132B are translated and sent as needed. Some of these additional messages 132A and 132B may be responses to previous messages.

The compatibility layer 103 enables components written according to the first framework 104 using the actor pattern to be executed according to the second framework 105 using the event based asynchronous pattern. As used herein, a message refers to any form of communication used by actors, threads, and other components to communicate with each other or with the framework. A message can refer to, among other things, any event or notification that is sent when a certain condition, event, or action occurs. A component generally refers to a logical entity or unit of work in a computing device, such as a process, thread, and the like.

Referring to FIG. 1B, illustrated is a more detailed diagram of compatibility layer 103 according to one embodiment. FIG. 1B illustrates event-based asynchronous framework 105 and actor framework 104. Event-based framework 105 further includes a message processor 120 configured to process messages according to the asynchronous framework 105. Compatibility layer 103 includes initial message processor 110 to perform initial message processing, a plurality of channels 125 for sending messages, a message correlator store 115 to enable mapping of messages between frameworks, actor interface 140 for interfacing to the actor framework 104, and asynchronous interface 141 for interfacing to the asynchronous framework 105. The actor framework 104 includes a scheduler 130, message queue 150 including messages 151, and actor allocated memory 160 with memory layout 161. The various components and functions are further referred to herein. It is also noted that the illustrated components and functions can be located in other systems and components than those illustrated in FIG. 1B.

The disclosed embodiments address issues such as that of threading and scheduling. It is desirable to write components in the asynchronous framework which appear as actors to the actor framework. In order for the asynchronous framework to function, code must be executed on one of its special threads, not a thread from an external pool. The work thus needs to be moved to the correct thread in order to take advantage of the asynchronous framework's capabilities. In an embodiment, the compatibility layer synchronously hands off messages to a channel as soon as the scheduler calls into the compatibility layer.

Solutions to threading/scheduling issues can also involve multi-stage message correlation, which includes determining which channel to send the message based on type and ID of the received message or other message details.

Memory ownership is one challenge in implementing a compatibility layer because there are some objects that are created by the actor framework (e.g., messages that have been sent) and some objects that are created by the user of the compatibility layer library (e.g., messages that have been sent, and context stored in the actor's memory), but may need to be destroyed (free the memory of) by the other framework. As used herein, the ‘owner’ of an object is the component or entity which is permitted to destroy the object. The disclosed embodiments address memory ownership as further described herein.

In an embodiment, the asynchronous framework is instructed by the compatibility layer (e.g., by means of its memory manager) not to destroy any objects that the compatibility layer has transferred ownership of to the actor framework (e.g., messages it has sent). Additionally, the compatibility layer may be configured to internally perform operations to provide this function. This may be accomplished, for example, by implementing the ‘Drop’ trait manually in Rust, so that when the messages are moved out of scope, the compatibility layer allocated memory is freed, leaving the actor framework able to free that memory when needed, or transfer ownership back to the compatibility layer.

Additionally, when messages are sent by the actor framework (ownership transfers to the compatibility layer) the actor framework ensures that the messages are not dropped and hence are not freed when they move out of scope in its logic. The compatibility layer then takes ownership of those objects and ensures that they are either freed when they are moved out of scope or that ownership is transferred back to the actor framework.

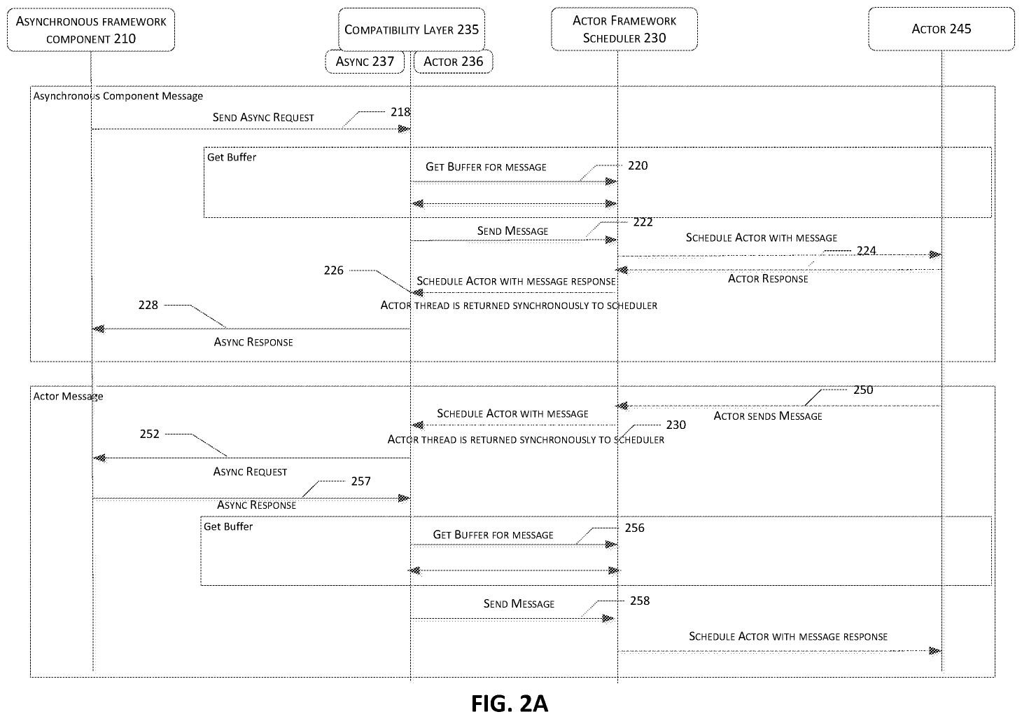

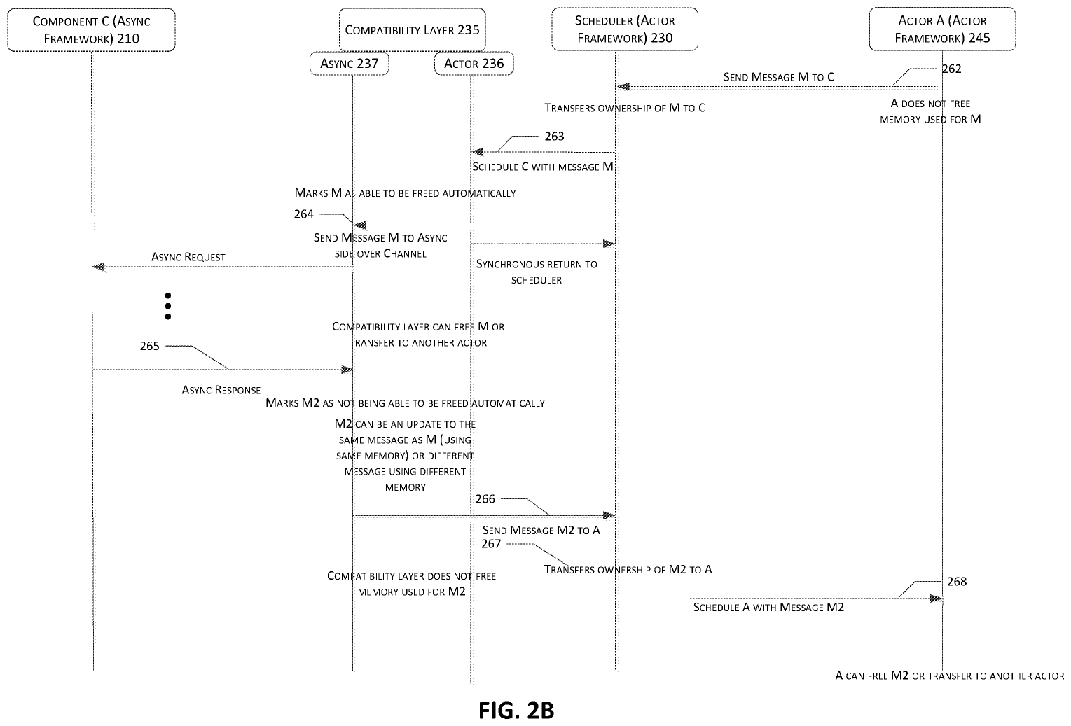

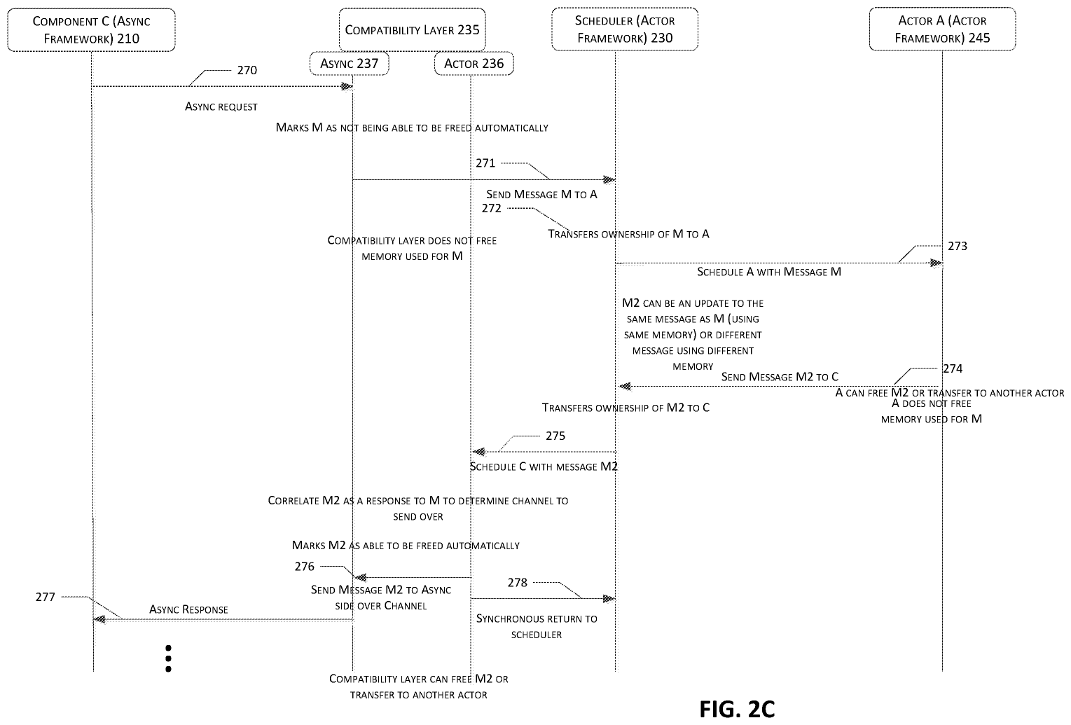

FIG. 2A illustrates a threading sequence diagram for threading in message sending (e.g., inter-component messaging), where an asynchronous framework component 210 is a component in an asynchronous framework that uses the compatibility layer 235 (and hence has actor framework memory and compatibility layer memory), and an actor 245 is an actor or old framework component. Thread ownership is denoted in FIG. 2A as either owned by the asynchronous framework using solid lines or the actor framework using dashed lines.

FIG. 2A illustrates two example scenarios: depicting when the asynchronous framework component 210 initiates a request and when the actor 245 initiates a request. Responses are optional. When the asynchronous framework component 210 initiates a request 218, the compatibility layer 235 requests a buffer 220 from the actor framework (if it does not already have one) to send the message to the actor framework and sends the message 222. If the actor framework 245 sends a response, the compatibility layer 235 performs correlation to determine which request it correlates to. The asynchronous response is sent to the asynchronous component and the actor thread is returned synchronously to the actor scheduler 224, so that other actors can be scheduled on that thread 226 and are not blocked. The asynchronous response is then returned to the asynchronous framework 228. When the actor component 245 initiates the request 250, the request is sent to the asynchronous framework by the compatibility layer 235 (by using the standard interface of the asynchronous framework 252 e.g., a channel or function call). The thread is returned synchronously to the actor scheduler 230. When the response is returned 257 the compatibility layer 235 requests a buffer 256 (if it does not have one of the appropriate size) and sends the response 258 to the actor scheduler.

Requesting buffers: if the actor framework 245 does not have any buffers (memory to be used for a message) available when one is requested, the actor framework 245 will track the request and notify when a buffer becomes available 220. The actor part 236 of the compatibility layer 235 will wait for the buffer availability notification and present it to the asynchronous part 237 of the compatibility layer in the standard way for an asynchronous framework (i.e., as if the buffer had returned synchronously). FIG. 2B provides additional details on the actor and asynchronous parts of the compatibility layer.

FIG. 2B expands on FIG. 2A by detailing functionality within the compatibility layer 235 when the compatibility layer 235 receives a message. In FIG. 2B, the message is received 262 from the actor framework. The scheduler 230 schedules component C 263 of the asynchronous framework with the message. The message is sent 264 to the asynchronous framework. The asynchronous response is sent 265 and an updated or new message is sent 266. Ownership is transferred to the actor framework 267 and scheduled 268.

FIG. 2C illustrates similar features to FIG. 2B except that the initial message 270 is received from the asynchronous framework 210. The message is sent 271 to the actor framework and ownership is transferred 272. The scheduler 230 schedules component A 273 of the actor framework with the message. The message is sent 274 and scheduler 230 schedules component C 275 of the asynchronous framework with the message. The message is sent 276 to the asynchronous framework and a synchronous return is sent 278 to the schedule 230. The asynchronous response is sent 277.

The compatibility layer 235 has two parts—an actor part 236 which acts as an actor to the actor framework (using actor framework threads) and an asynchronous part 237 which acts as an asynchronous component to the asynchronous framework (and uses asynchronous framework threads). This is so that each framework is unaware that it is communicating with components of the other framework.

Receiving messages from the actor framework: Referring to FIG. 2A, the compatibility layer (actor part 236) 235 receives a message from the actor framework 210, a ‘process message’ callback is invoked on an actor framework thread 224, and the work is moved to an asynchronous framework thread (in the asynchronous part 237 of the compatibility layer 235) before the message is processed, so that the actor thread can return synchronously 226. This is done by sending the message down a channel to the asynchronous 237 part of the compatibility layer 235 and then synchronously returning to the actor scheduler 230. The asynchronous part 237 can then process the message and send to the asynchronous framework asynchronously.

Receiving messages from the asynchronous framework: On the actor framework thread in the actor part 236, the following is performed by the compatibility layer 235:

The message receiver identifies whether it can correlate the message as a response to a previously sent message (using multi-stage message correlation, as previously described).

If so, the response is passed down the appropriate channel, passing the message to an asynchronous framework thread. Otherwise, the message receiver passes the message to the interface-wide channel for this interface and then returns.

Alternatively, all messages may be passed onto the interface-wide general channel and the correlation as described above may be performed on an asynchronous framework thread rather than on the actor framework thread by the compatibility layer 235.

Correlation: Correlation of messages addresses two issues. One issue is that messages have different methods of correlation (different types of correlator and different fields to be correlated). Another issue is that the method of correlation and response channels need to be accessible from both an actor framework thread and an asynchronous framework thread/executor, meaning there needs to be some kind of shared memory.

In one embodiment, a shared correlator store is implemented which provides a method to extract potentially multiple correlator fields from a message and a compatibility layer scoped hash map which provides a map from the values of the fields to the channel that the response should be sent down.

When a response is received from the asynchronous framework, there is no need to transfer to the actor thread in order to send the message M2 to the actor framework, as the actor framework will return synchronously to the asynchronous part of the compatibility layer—therefore the asynchronous part of the compatibility layer sends directly to the actor scheduler in 266.

Another issue that the present disclosure addresses is that of memory. To schedule work on an actor, the actor scheduler calls into the actor on an actor-owned thread and provides the actor with the context it needs to be able to perform work.

One issue pertaining to memory is that when writing an actor in the new (asynchronous) framework, some context is needed for the asynchronous framework (e.g., which channel to send the message down or how to access the Correlator Map). In an embodiment, ‘new framework’ or ‘asynchronous framework’ metadata is placed into the actor context (which is owned by the old framework).

One option is to store the metadata in a manner that the actor framework can understand (e.g., an integer which can be looked up in a global state stored by the compatibility layer). Another option is to store the context using the memory model of the asynchronous framework (e.g., Rust layout structures inside C layout structures) which is either completely opaque to the actor framework, or invisible to the actor framework (for example, the asynchronous Rust structure may be appended to the actor's C structure and hence the actor does not know that it exists). One advantage of this option is that the option avoids using global variables (which may pollute the namespace of the actor framework) and potentially provide performance benefits. Another advantage is that the option is generalizable to other situations where two memory models are used but memory sharing is needed.

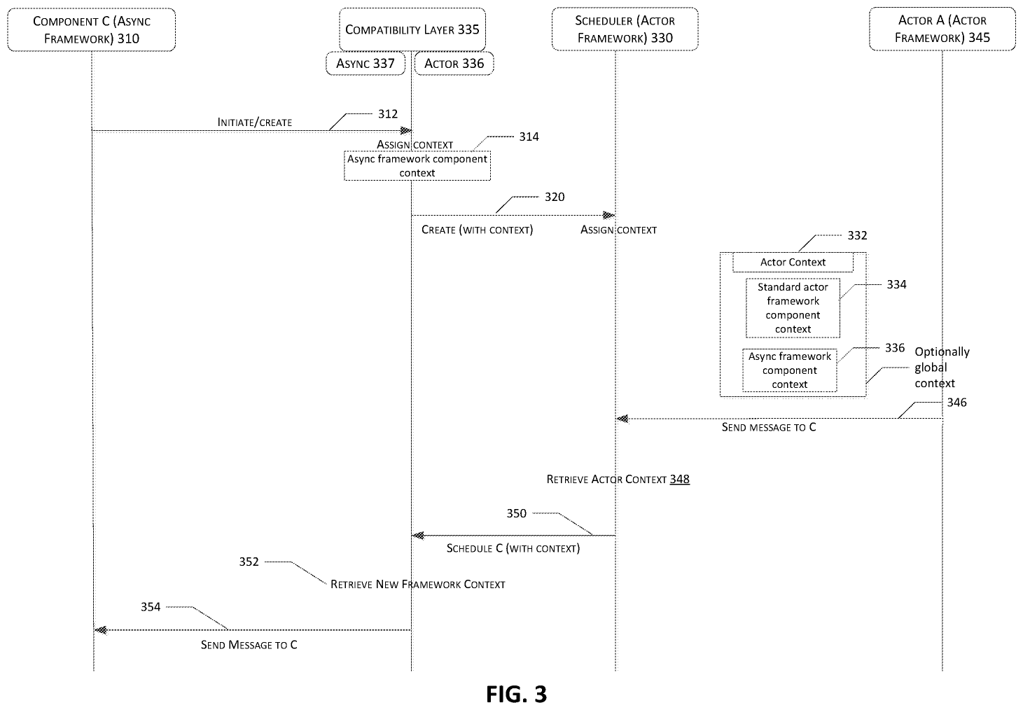

Referring to FIG. 3, in an embodiment each actor in the actor framework 345 provides for a per-actor context which is permitted to be defined by the actor itself. The contexts are assigned and stored 314 at initialization time 312 of the actor by the actor itself. The compatibility layer 335 uses this to store a context. This may use “async framework” memory layout. When the scheduler 330 schedules the “compatibility layer” actor (providing the standard “actor framework” context) 334, the compatibility layer 335 can extract the “async framework” context 336 and use it e.g., for the request/response correlation described above (e.g., the location of the correlation map may be stored in this context). The message is sent 346 to the asynchronous framework. Context is retrieved 348 and component C is scheduled with context 350. New framework context is retrieved 352 and the message is sent to component C 354.

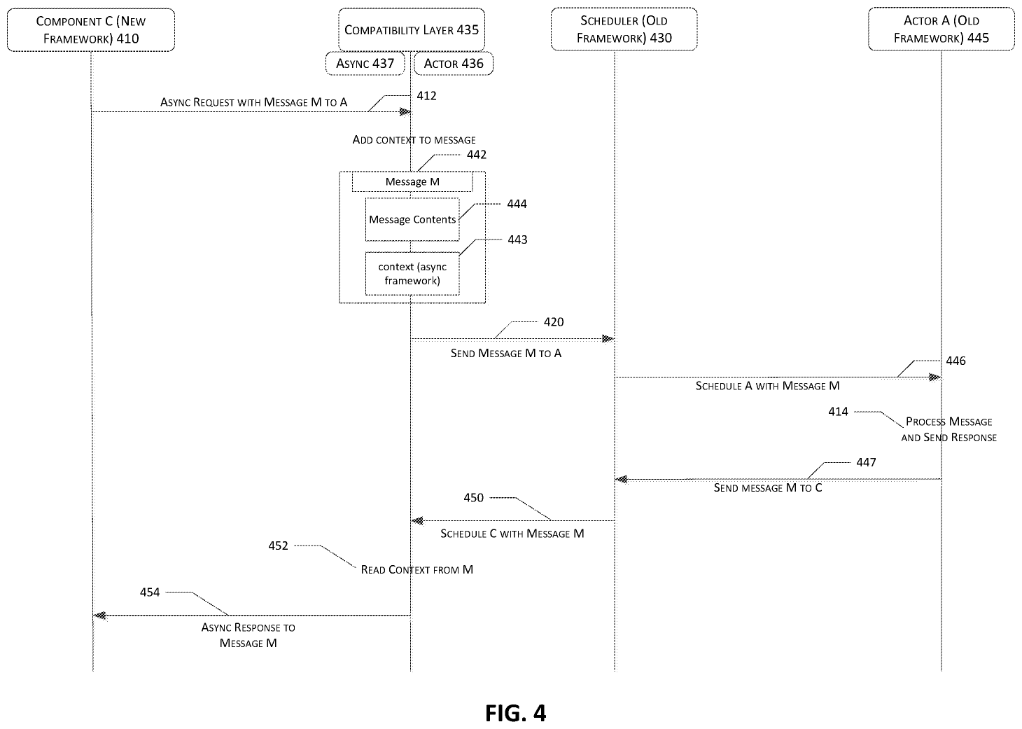

Referring to FIG. 4, in an embodiment the actor framework 445 provides that contexts are stored on each message rather than per-actor. In this case, the actor framework 445 stores a context (which may use “async framework” memory layout) when the message is sent to the actor framework 445 by the compatibility layer 435. When the scheduler schedules the “compatibility layer” actor with the message, the compatibility layer 435 can extract the “asynchronous framework” context and use it for e.g., the request/response correlation described above (e.g., the channel over which to pass the message M in 265 of FIG. 2B may be stored in the context). The message is sent 420 to the actor framework. Component A is scheduled with the message 446 and the message is processed 414. The message is sent 447 to the asynchronous framework. Component AC is scheduled with the message 450 and the context is read 452 from the message. The asynchronous response to the message is provided 454 to component C in the asynchronous or new framework.

FIG. 3 illustrates the context being stored per-actor, as discussed above with reference to memory issues. It should be noted that if the asynchronous framework's context is stored at the end of the structure, it is possible that the actor framework is not aware of its existence.

FIG. 4 illustrates the context being stored per-message. It should be noted that if the asynchronous framework's context is stored at the end of the structure, it is possible that the actor framework is not aware of its existence.

A further issue pertaining to memory is that when the old framework scheduler calls into the asynchronous framework, it will pass memory owned by the “old (actor) framework”. This may contain self-referential structures and should not be copied to avoid making the structure invalid. In an embodiment, the compatibility layer provides functionality to mandate that the memory should not be moved by components in the asynchronous framework. For example, memory pinning could be used, which is a feature of the Rust language.

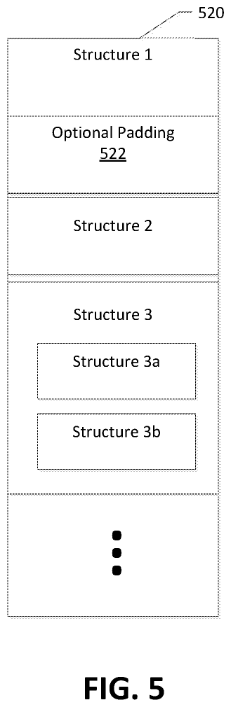

Another issue pertaining to memory is that the actor framework has contiguous memory which represents multiple structures stored in the same contiguous block of memory (sometimes nested, and sometimes with gaps in between). In an embodiment, the compatibility layer enables the asynchronous framework to interoperate with the actor framework's format by retaining the byte-level ordering and structure of the memory for each framework so that each framework can each use their own native structures. The compatibility layer reads and writes to those structures so that the individual frameworks do not need to be modified to account for the difference in structures. An example is illustrated in FIG. 5. Structures 520 may have optional padding 522 between them and may be nested to an arbitrary depth. Structures may be of the same or different types.

Another issue pertaining to memory is that of multiple memory managers, as the asynchronous and actor frameworks each manage their own memory. With regard to this issue, one problem is the need to avoid memory bugs (e.g., memory leaks or “use after free”) when passing data between the actor and asynchronous frameworks. Another problem is that it is desirable that components written in each framework use their own memory manager in an idiomatic way (not needing to do something special because data might be passed to the other framework).

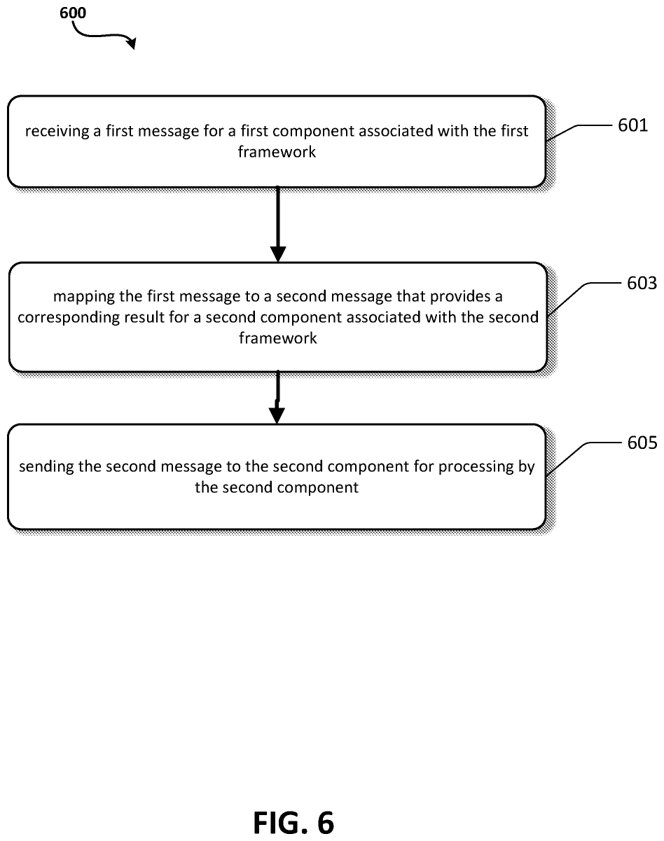

In an embodiment, ownership transfer may be implemented where any messages passed across the boundary to the compatibility layer transfer their ownership to the other framework. For example, any “old (actor) framework” objects are freed by the compatibility layer when no longer required. Additionally, any “new (asynchronous) framework” objects passed to the “old (actor) framework” are marked by the compatibility layer as ‘not to be freed automatically’, which can be a feature provided by the asynchronous framework. Some garbage collected languages, and languages such as Rust which free when out of scope provide this feature. FIG. 6 illustrates an example.

In another embodiment, the same memory manager may be used, which allows the asynchronous framework to use the actor framework's memory manager.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

FIG. 6 illustrates aspects of a routine 600 for implementing aspects of the techniques disclosed herein as shown and described below. It should be understood that the operations of the methods disclosed herein are not presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 600 are described herein as being implemented, at least in part, by modules running the features disclosed herein and can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it can be appreciated that the operations of the routine 600 may be also implemented in many other ways. For example, the routine 600 may be implemented, at least in part, by a processor of another remote computer or a local circuit. In addition, one or more of the operations of the routine 600 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

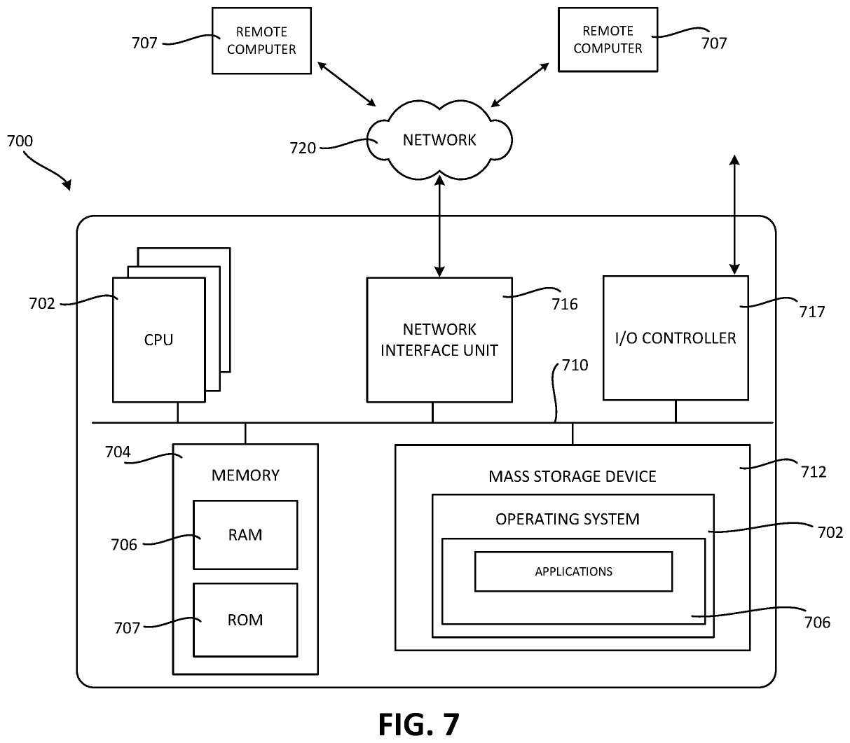

The operations in FIG. 6 can be performed, for example, by the computing device 700 of FIG. 7, as described above with respect to any one of FIGS. 1-6.

At operation 601, the compatibility layer receives a first message for a first component associated with the first framework.

At operation 603, the compatibility layer maps the first message to a second message that provides a corresponding result for a second component associated with the second framework.

At operation 605, the compatibility layer sends the second message to the second component for processing by the second component. The compatibility layer is exposed as an actor to the framework using the actor pattern and exposed as an asynchronous component to the framework using the event based asynchronous pattern, thereby enabling the first and second frameworks to interoperate and enabling threading models of the first and second frameworks to be adhered to by the compatibility layer. Additional messages can be mapped and sent.

FIG. 7 is a computer architecture diagram showing an illustrative computer hardware and software architecture for a computing device that can execute various aspects of the present disclosure, such as those described above with regard to FIGS. 1-7, according to one implementation. In particular, the architecture illustrated in FIG. 7 can be utilized to implement a server computer, a desktop computer, a laptop computer, or another type of computing device.

The computer 700 illustrated in FIG. 7 includes a central processing unit 702 (“CPU” or “processor”), a system memory 704, including a random-access memory 706 (“RAM”) and a read-only memory (“ROM”) 708, and a system bus 710 that couples the memory 704 to the CPU 702. A basic input/output system (“BIOS” or “firmware”) containing the basic routines that help to transfer information between elements within the computer 700, such as during startup, can be stored in the ROM 707. The computer 700 further includes a mass storage device 712 for storing an operating system 702, application programs, and other types of programs. The mass storage device 712 can also be configured to store other types of programs and data.

The mass storage device 712 is connected to the CPU 702 through a mass storage controller (not shown in FIG. 7) connected to the bus 710. The mass storage device 712 and its associated computer readable media provide non-volatile storage for the computer 700. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other computer storage medium that can be used to store the desired information and which can be accessed by the computer 700. For purposes of the claims, the phrase “computer storage medium,” and variations thereof, does not include waves or signals per se or communication media.

According to various configurations, the computer 700 can operate in a networked environment using logical connections to remote computers through a network such as the network 720. The computer 700 can connect to the network 720 through a network interface unit 716 connected to the bus 710. It should be appreciated that the network interface unit 716 can also be utilized to connect to other types of networks and remote computer systems. The computer 700 can also include an input/output controller 717 for receiving and processing input from a number of other devices, including a keyboard, mouse, touch input, an electronic stylus (not shown in FIG. 7), or a physical sensor such as a video camera. Similarly, the input/output controller 717 can provide output to a display screen or other type of output device (also not shown in FIG. 7).

It should be appreciated that the software components described herein, when loaded into the CPU 702 and executed, can transform the CPU 702 and the overall computer 700 from a general-purpose computing device into a special-purpose computing device customized to facilitate the functionality presented herein. The CPU 702 can be constructed from any number of transistors or other discrete circuit elements, which can individually or collectively assume any number of states. More specifically, the CPU 702 can operate as a finite-state machine, in response to executable instructions contained within the software modules disclosed herein. These computer-executable instructions can transform the CPU 702 by specifying how the CPU 702 transitions between states, thereby transforming the transistors or other discrete hardware elements constituting the CPU 702.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 700 in order to store and execute the software components presented herein. It also should be appreciated that the architecture shown in FIG. 7 for the computer 700, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 700 might not include all of the components shown in FIG. 7, can include other components that are not explicitly shown in FIG. 7, or can utilize an architecture completely different than that shown in FIG. 7.

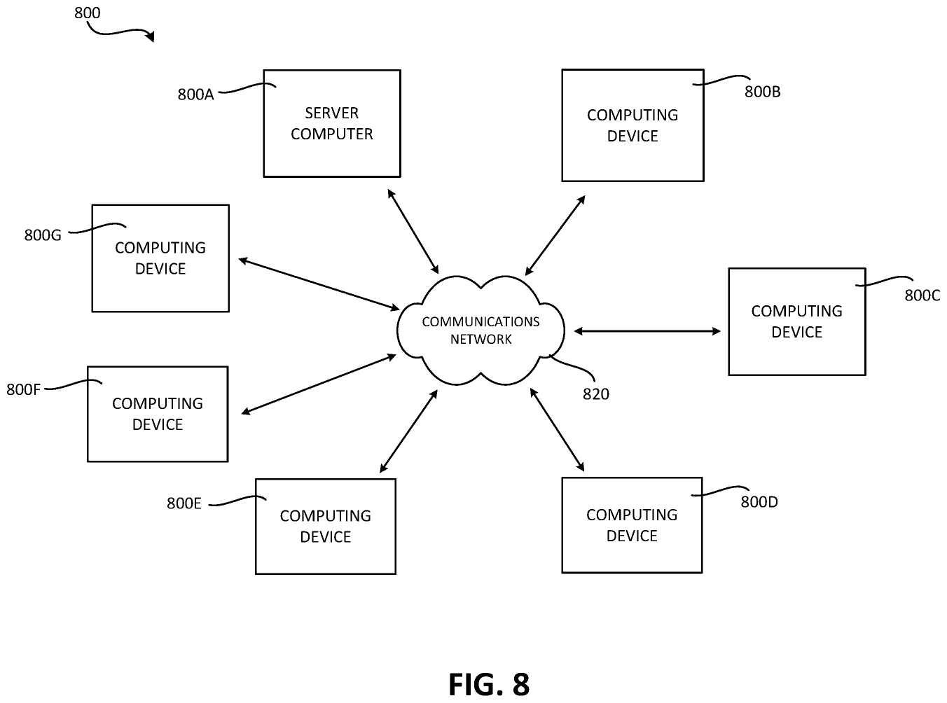

FIG. 8 is a network diagram illustrating a distributed network computing environment 800 in which aspects of the disclosed technologies can be implemented, according to various implementations presented herein. As shown in FIG. 8, one or more server computers 800A can be interconnected via a communications network 820 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 800B, a gaming console 800C, a smart watch 800D, a telephone 800E, such as a smartphone, a personal computer 800F, and an AR/VR device 800G.

In a network environment in which the communications network 820 is the Internet, for example, the server computer 800A can be a dedicated server computer operable to process and communicate data to and from the client computing devices 800B-800G via any of a number of known protocols, such as, hypertext transfer protocol (“HTTP”), file transfer protocol (“FTP”), or simple object access protocol (“SOAP”). Additionally, the networked computing environment 800 can utilize various data security protocols such as secured socket layer (“SSL”) or pretty good privacy (“PGP”). Each of the client computing devices 800B-800G can be equipped with an operating system operable to support one or more computing applications or terminal sessions such as a web browser (not shown in FIG. 5), or other graphical user interface (not shown in FIG. 5), or a mobile desktop environment (not shown in FIG. 8) to gain access to the server computer 800A.

The server computer 800A can be communicatively coupled to other computing environments (not shown in FIG. 8) and receive data regarding a participating user's interactions/resource network. In an illustrative operation, a user (not shown in FIG. 8) may interact with a computing application running on a client computing device 800B-800G to obtain desired data and/or perform other computing applications.

The data and/or computing applications may be stored on the server 800A, or servers 800A, and communicated to cooperating users through the client computing devices 800B-800G over an exemplary communications network 820. A participating user (not shown in FIG. 8) may request access to specific data and applications housed in whole or in part on the server computer 800A. These data may be communicated between the client computing devices 800B-800G and the server computer 800A for processing and storage.

The server computer 800A can host computing applications, processes and applets for the generation, authentication, encryption, and communication of data and applications, and may cooperate with other server computing environments (not shown in FIG. 8), third party service providers (not shown in FIG. 8), network attached storage (“NAS”) and storage area networks (“SAN”) to realize application/data transactions.

It should be appreciated that the computing architecture shown in FIG. 8 and the distributed network computing environment shown in FIG. 8 have been simplified for ease of discussion. It should also be appreciated that the computing architecture and the distributed computing network can include and utilize many more computing components, devices, software programs, networking devices, and other components not specifically described herein.

Based on the foregoing, it should be appreciated that a framework has been disclosed that enables the interoperability of various frameworks. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The disclosure presented herein also encompasses the subject matter set forth in the following clauses:

Clause 1: A method of enabling interoperation between a first framework and a second framework in a system running a compatibility layer configured to enable the interoperation between the first framework and the second framework, wherein one of the frameworks uses an actor pattern and the other framework uses an event based asynchronous pattern, and wherein the system supports the first and second frameworks, the method comprising:
receiving, by the compatibility layer, a first message for a first component associated with the first framework;
mapping, by the compatibility layer, the first message to a second message that provides a corresponding result for a second component associated with the second framework; and
sending, by the compatibility layer, the second message to the second component for processing by the second component, wherein the compatibility layer is exposed as an actor to the framework using the actor pattern and exposed as an asynchronous component to the framework using the event based asynchronous pattern, thereby enabling the first and second frameworks to interoperate and enabling threading models of the first and second frameworks to be adhered to by the compatibility layer.

Clause 2: The method of clause 1, further comprising waiting for a response to the second message from the second component and mapping the response to the second message to a response to the first message from the first component.

Clause 3: The method of any of clauses 1-2, wherein structures from the first framework are stored in a part of memory associated with the second framework, further comprising using the structures to access shared state across multiple threads.

Clause 4: The method of any of clauses 1-3, wherein unknown structures are dynamically cast to specifically typed structures based on a field in the message.

Clause 5: The method of any of clauses 1-4, wherein the compatibility layer synchronously hands off messages to an asynchronous channel when an actor framework scheduler calls into the compatibility layer.

Clause 6: The method of any of clauses 1-5, wherein the second framework is instructed not to free memory of any objects that the second framework has transferred ownership of to the first framework.

Clause 7: The method of clauses 1-6, further comprising when messages are sent by the first framework, the first framework does not drop the messages and the compatibility layer takes ownership of the messages and ensures that the messages are either freed by the second framework or passed back to the first framework.

Clause 8: The method of any of clauses 1-7, wherein the compatibility layer prevents memory from being moved by components between frameworks.

Clause 9: The method of any of clauses 1-8, further comprising storing metadata in memory allocated by the first framework.

Clause 10: The method of any of clauses 1-9, wherein the metadata is stored using a memory model of the second framework.

Clause 11: The method of any of clauses 1-10, wherein the memory model is opaque to the first framework.

Clause 12: The method of any of clauses 1-11, further comprising: determining whether a message from the first framework can be correlated as a response to a previously sent message; and one of: converting the message to a response according to the second framework and sending the converted response to the second framework or converting the message to a request according to the second framework and sending the converted request to the second framework.

Clause 13: The method of any of clauses 1-12, further comprising using specific per-request channels to track where to send asynchronous responses to requests from the framework using the event based asynchronous pattern and a per-framework channel to track sending requests to the framework using the event based asynchronous pattern.

Clause 14: The method of any of clauses 1-13, further comprising including a mapping for extracting a field from a message and a mapping from a value of the field to a channel corresponding to an asynchronous request to enable an asynchronous response to be sent to that request.

Clause 15: The method of any of clauses 1-14, further comprising performing multi-stage message correlation including determining which channel to send a received message based on a type and ID of the received message.

Clause 16: The method of any of clauses 1-15, wherein the compatibility layer enables the first and second frameworks to interoperate without modifying the first and second frameworks to enable the interoperation.

Clause 17: A system comprising:
a processing system comprising a processor; and computer-readable media having thereon computer-executable instructions that are structured such that, when executed by the processing system, cause the computing system to perform operations comprising:
executing a compatibility layer configured to enable interoperation between a first framework and a second framework, wherein a first one of the first or second frameworks uses an actor pattern and a second one of the first or second frameworks uses an event based asynchronous pattern;
receiving, by the compatibility layer, a first message for a first process component with a first framework;
mapping, by the compatibility layer, the first message to a second message that provides a corresponding result for a second component associated with a second framework; and
sending, by the compatibility layer, the second message to the second component for processing by the second component;
wherein the compatibility layer is exposed as an actor to the framework using the actor pattern and exposed as an asynchronous component to the framework using the event based asynchronous pattern, thereby enabling the first and second frameworks to interoperate and enabling threading models of the first and second frameworks to be adhered to by the compatibility layer.

Clause 18: The system of clause 17, wherein structures from the first framework are stored in a part of memory associated with the second framework, further comprising using the structures to access shared state across multiple threads.

Clause 19: The system of any of clauses 17 and 18, wherein the compatibility layer enables the first and second frameworks to interoperate without modifying the first and second frameworks to enable the interoperation.

Clause 20: A computer-readable storage medium having thereon computer-executable instructions that are structured such that, when executed by a processing system of a computing system, cause the computing system to perform operations comprising:
executing a compatibility layer configured to enable interoperation between a first framework and a second framework, wherein a first one of the first or second frameworks uses an actor pattern and a second one of the first or second frameworks uses an event based asynchronous pattern;
receiving, by the compatibility layer, a first message for a first process component with a first framework;
mapping, by the compatibility layer, the first message to a second message that provides a corresponding result for a second component associated with a second framework; and
sending, by the compatibility layer, the second message to the second component for processing by the second component;
wherein the compatibility layer is exposed as an actor to the framework using the actor pattern and exposed as an asynchronous component to the framework using the event based asynchronous pattern, thereby enabling the first and second frameworks to interoperate and enabling threading models of the first and second frameworks to be adhered to by the compatibility layer.

What is claimed is:

1. A method of enabling interoperation between a first framework and a second framework in a system running a compatibility layer configured to enable the interoperation between the first framework and the second framework, wherein one of the frameworks uses an actor pattern and the other framework uses an event based asynchronous pattern, and wherein the system supports the first and second frameworks, the method comprising:
receiving, by the compatibility layer, a first message for a first component associated with the first framework;
mapping, by the compatibility layer, the first message to a second message that provides a corresponding result for a second component associated with the second framework; and
sending, by the compatibility layer, the second message to the second component for processing by the second component, wherein the compatibility layer is exposed as an actor to the framework using the actor pattern and exposed as an asynchronous component to the framework using the event based asynchronous pattern, thereby enabling the first and second frameworks to interoperate and enabling threading models of the first and second frameworks to be adhered to by the compatibility layer.

2. The method of claim 1, further comprising waiting for a response to the second message from the second component and mapping the response to the second message to a response to the first message from the first component.

3. The method of claim 1, wherein structures from the first framework are stored in a part of memory associated with the second framework, further comprising using the structures to access shared state across multiple threads.

4. The method of claim 1, wherein unknown structures are dynamically cast to specifically typed structures based on a field in the message.

5. The method of claim 1, wherein the compatibility layer synchronously hands off messages to an asynchronous channel when an actor framework scheduler calls into the compatibility layer.

6. The method of claim 1, wherein the second framework is instructed not to free memory of any objects that the second framework has transferred ownership of to the first framework.

7. The method of claim 1, further comprising when messages are sent by the first framework, the first framework does not drop the messages and the compatibility layer takes ownership of the messages and ensures that the messages are either freed by the second framework or passed back to the first framework.

8. The method of claim 1, wherein the compatibility layer prevents memory from being moved by components between frameworks.

9. The method of claim 1, further comprising storing metadata in memory allocated by the first framework.

10. The method of claim 9, wherein the metadata is stored using a memory model of the second framework.

11. The method of claim 10, wherein the memory model is opaque to the first framework.

12. The method of claim 1, further comprising:
determining whether a message from the first framework can be correlated as a response to a previously sent message; and
one of: converting the message to a response according to the second framework and sending the converted response to the second framework or
converting the message to a request according to the second framework and sending the converted request to the second framework.

13. The method of claim 12, further comprising using specific per-request channels to track where to send asynchronous responses to requests from the framework using the event based asynchronous pattern and a per-framework channel to track sending requests to the framework using the event based asynchronous pattern.

14. The method of claim 13, further comprising including a mapping for extracting a field from a message and a mapping from a value of the field to a channel corresponding to an asynchronous request to enable an asynchronous response to be sent to that request.

15. The method of claim 14, further comprising performing multi-stage message correlation including determining which channel to send a received message based on a type and ID of the received message.

16. The method of claim 14, wherein the compatibility layer enables the first and second frameworks to interoperate without modifying the first and second frameworks to enable the interoperation.

17. A computing system comprising:
a processing system comprising a processor; and
computer-readable media having thereon computer-executable instructions that are structured such that, when executed by the processing system, cause the computing system to perform operations comprising:
executing a compatibility layer configured to enable interoperation between a first framework and a second framework, wherein a first one of the first or second frameworks uses an actor pattern and a second one of the first or second frameworks uses an event based asynchronous pattern;
receiving, by the compatibility layer, a first message for a first process component with a first framework;
mapping, by the compatibility layer, the first message to a second message that provides a corresponding result for a second component associated with a second framework; and
sending, by the compatibility layer, the second message to the second component for processing by the second component;
wherein the compatibility layer is exposed as an actor to the framework using the actor pattern and exposed as an asynchronous component to the framework using the event based asynchronous pattern, thereby enabling the first and second frameworks to interoperate and enabling threading models of the first and second frameworks to be adhered to by the compatibility layer.

18. The computing system of claim 17, wherein structures from the first framework are stored in a part of memory associated with the second framework, further comprising using the structures to access shared state across multiple threads.

19. The computing system of claim 17, wherein the compatibility layer enables the first and second frameworks to interoperate without modifying the first and second frameworks to enable the interoperation.

20. A computer-readable storage medium having thereon computer-executable instructions that are structured such that, when executed by a processing system of a computing system, cause the computing system to perform operations comprising:
executing a compatibility layer configured to enable interoperation between a first framework and a second framework, wherein a first one of the first or second frameworks uses an actor pattern and a second one of the first or second frameworks uses an event based asynchronous pattern;
receiving, by the compatibility layer, a first message for a first process component with a first framework;
mapping, by the compatibility layer, the first message to a second message that provides a corresponding result for a second component associated with a second framework; and
sending, by the compatibility layer, the second message to the second component for processing by the second component;
wherein the compatibility layer is exposed as an actor to the framework using the actor pattern and exposed as an asynchronous component to the framework using the event based asynchronous pattern, thereby enabling the first and second frameworks to interoperate and enabling threading models of the first and second frameworks to be adhered to by the compatibility layer.
